(19) United States
(12) Patent Application Publication
(10) Pub. No.: US 2005/0091206 A1
(43) Pub. Date: Apr. 28, 2005

(54) Method and system for handling data available in multidimensional databases using a spreadsheet

(76) Inventors: Francois Koukerdjinian, Boulogne Billancourt (FR); Jean-Philippe Jauffret, Piscop (FR)

Correspondence Address: MILES & STOCKBRIDGE PC, 1751 PINNACLE DRIVE, SUITE 500, MCLEAN, VA, 22102-3833, US

(21) Appl. No.: 10/937,874

(22) Filed: Sep. 10, 2004

(30) Foreign Application Priority Data
Sep. 10, 2003 (FR) FR 03/10656

(51) Int. Cl. G06F 7/00

(52) U.S. Cl. 707/3

(57) ABSTRACT

To handle data stored in a multidimensional database in which the data is structured according to a number of dimensions, this process includes steps consisting in: generating a query to extract data from the multidimensional database based on selection criteria introduced by a user relating to at least part of the dimensions of the multidimensional database; executing the data extraction query on the multidimensional database so as to receive data extracted from the multidimensional database and corresponding to the selection criteria introduced by the user; storing the data received in the form of an elementary data block in a local database; and inserting into spreadsheet cells a formula for displaying a data item that points to a respective data item of the elementary data block stored in the local database.

### FIELD OF THE INVENTION

The present invention relates to manipulating data available in multidimensional databases.

It applies particularly, but not exclusively, to the design and construction on a computer of management reports using structured data and to which the designer adds additional locally-defined custom indicators, the structured data coming from one or several multidimensional databases that can be accessed from one or several servers via a data network.

### BACKGROUND OF THE INVENTION

A multidimensional database has a multidimensional matrix structure, each data item in this matrix structure being identified in a unique way by selecting a particular member value on each dimension of the structure. Additionally, each dimension member in the data structure can be associated with other information known as “properties”.

Management reports are generally built using a spreadsheet software, for example of the Microsoft EXCEL type, running on a computing machine such as a personal computer. Such a software is commonly used to create and handle numerical or alphanumerical tables, in business and scientific applications.

A number of issues must be addressed when designing a management report. First of all the structure of the databases from which the data is extracted is generally different from how the user wishes to view the same data in the management report. Extracted data is “symmetrical”: a symmetrical intersection of dimensions, while a management report data presentation generally has no symmetry.

To solve this problem a solution would be to insert into each cell of the management report a calculation formula consisting of a query for the corresponding data item to be extracted from the database. This solution proves to be laborious especially when the database is on a remote server accessed via a network. Additionally, this solution is not within the reach of a non-specialist user since it requires a fairly good knowledge of the query language. This solution presents major risks of inconsistency errors due to wrong data selections, and has high operating and maintenance costs, particularly when a selection criterion needs to be modified to select other data to be extracted from the database.

The solutions commonly used consist in projecting in a spreadsheet multidimensional blocks extracted from the database. Each extracted block is presented in the form of a data table. The data block dimensions are displayed along the rows and columns, possibly embedding several dimensions.

This solution addresses only partially the need of designing management reports. Indeed a management report does not aim simply to present raw data from databases, but also to apply processing operations to this data. These processing operations are generally defined as formulas inserted into certain cells of the spreadsheet. If a criterion for selecting the extracted data block is modified involving a modification of the size of the projected table, the formulas may be overwritten when the spreadsheet is updated.

Neither does this solution allow the structure of the projected table to be modified, for example by inserting additional rows or columns in order to display therein values obtained via calculation formulas applied to the table values.

Nor does this solution, when the management report includes more than one block, allow these blocks to be made consistent. In particular, if a projected data block selection criterion is modified, no mechanism is provided to propagate this modification to the other blocks.

### SUMMARY OF THE INVENTION

The purpose of the present invention is to suppress these drawbacks. This objective is met by providing a method for handling data stored in at least one multidimensional database in which data is structured according to a number of dimensions.

According to the invention, this method comprises steps of:
generating a query for extracting data from a multidimensional database based on selection criteria introduced by a user relating to at least part of the dimensions of the multidimensional database,
executing the data extraction query on the multidimensional database so as to receive data extracted from the multidimensional database and corresponding to the selection criteria introduced by the user,
storing the data received in the form of an elementary data block in a local database, and
inserting into cells of a spreadsheet formulas for displaying a data item that point to a respective data item of the elementary data block stored in the local database.

Advantageously, the selection criteria introduced by the user for an extracted elementary data block are stored in the local database in association with the extracted and stored elementary data block.

According to a preferred embodiment of the invention, this method further comprises steps of generating and executing a number of data extraction queries, as a function of selection criteria introduced by the user so as to receive a number of elementary data blocks, each of the extracted elementary data blocks being stored in the local database, and inserted in the form of a respective table into the spreadsheet as a function of the selection criteria introduced by the user for each of the extracted elementary data blocks.

According to a preferred embodiment of the invention, this method includes a step of linking at least one dimension of an elementary slave data block to an elementary master data block, the generation of the query for extracting the elementary slave data block integrating the selection criteria applied to the linked dimension of the elementary master data block.

According to a preferred embodiment of the invention, if the linked dimension of the elementary master data block is itself linked to a dimension of another elementary data block, the selection criteria applied to the dimension of the other elementary data block are applied to the linked dimension of the elementary slave data block.

According to a preferred embodiment of the invention, each time a criterion for selecting a linked dimension of a master elementary master data block is modified, the queries for extraction of the elementary slave data blocks from the elementary master data block are generated and executed again so as to update the cells in the tables of elementary data block data inserted into the spreadsheet.

According to a preferred embodiment of the invention, this method further comprises a procedure for extending multidimensional calculation to at least one dimension of an elementary data block, including a step of identifying in the spreadsheet a set of cells that groups cells containing data item display formulas that point to respective data in an elementary data block, corresponding to a first respective member of each of the dimensions of the elementary block for which the extension procedure has been activated, and cells inserted by the user, and steps of duplicating the identified cell set, carried out for each of the members of each of the dimensions for which the extension procedure has been activated, each duplication being carried out by modifying the data display formulas of the elementary data block, belonging to the identified cell set, so as to insert an elementary data block corresponding to the members for which the duplication is being carried out.

According to a preferred embodiment of the invention, the cells inserted by the user in the identified cell set contain at least partially calculation formulas that reference cells in the identified cell set, the identified cell set being duplicated by updating the references of the cells that feature in the calculation formulas inserted by the user as a function of the location in the spreadsheet where the identified set is inserted.

The invention also relates to a system for handling data stored in at least one multidimensional database in which data is structured according to a number of dimensions.

According to the invention, this system comprises an interface module coupled with a spreadsheet software and having access to at least one multidimensional database to extract elementary data blocks from the multidimensional database and insert them into a spreadsheet, and a local database in which the interface module stores the extracted elementary data block data, the interface module including:
means for generating queries for extracting elementary data blocks from the multidimensional database based on selection criteria introduced by a user relating to at least a part of the dimensions of the multidimensional database,
means for making the multidimensional database execute the generated extraction queries,
means for receiving the extracted elementary data blocks and storing them in the local database, and
means for inserting into cells of the spreadsheet data item display formulas that point to respective data items in the elementary data block stored in the local database.

Advantageously, the multidimensional databases are accessible to the interface module via data networks.

According to a preferred embodiment of the invention, the local database stores several elementary data blocks extracted from multidimensional databases, the interface module including means for allowing the user to link together at least one dimension of an elementary slave data block and a corresponding dimension of an elementary master data block, and means for integrating the selection criteria applied to the linked dimension of the elementary master data block into the elementary slave data block extraction query.

According to a preferred embodiment of the invention, the interface module additionally includes means for retrieving all the elementary blocks stored in the local database that include at least one dimension linked to an elementary master block when a criterion for selecting the corresponding linked dimension of the elementary master block is modified, means for generating and executing queries for extracting the elementary slave blocks found and means for updating the cells in the data tables of the elementary blocks inserted into the spreadsheet, following the execution of the extraction queries.

According to a preferred embodiment of the invention, this system additionally includes means for identifying in the spreadsheet a cell set that groups together cells containing data item display formulas that point to a respective data item in an elementary data block, corresponding to a first respective member of at least one dimension of the elementary block for which a multidimensional calculation extension procedure has been activated, and cells inserted by the user, means for duplicating the identified cell set for each of the members of each of the dimensions for which the extension procedure has been activated, each duplication being carried out by modifying the elementary data block data display formulas, belonging to the identified cell set, so as to point to elementary block data corresponding to the members for which the duplication is being carried out.

According to a preferred embodiment of the invention, the cells inserted by the user in the identified cell set contains calculation formulas that reference cells in the identified cell set, the identified cell set being duplicated by updating the references of the cells that feature in the calculation formulas inserted by the user as a function of the location in the spreadsheet where the identified set is copied.

### BRIEF DESCRIPTION OF THE DRAWINGS

A preferred embodiment of the invention will be described hereinafter, as a non-restrictive example, with reference to the appended drawings in which:

FIG. 1 shows a system in which the process according to the invention may be performed;

FIG. 2 shows in more detail a terminal of the system shown in FIG. 1, allowing data from multidimensional bases to be handled;

FIG. 3 shows an example of part of an elementary data block inserted into a spreadsheet;

FIG. 4 shows in the form of a system diagram different steps implemented by the method according to the invention on the terminal shown in FIG. 2, for each of the elementary blocks constituting a management report to be designed;

FIGS. 5a and 5b show another example of two elementary data blocks inserted into a spreadsheet and linked together according to the invention;

FIGS. 6a and 6b show an example of the processing operation carried out by the extension function according to the invention.

### DETAILED DESCRIPTION OF PREFERRED EMBODIMENTS

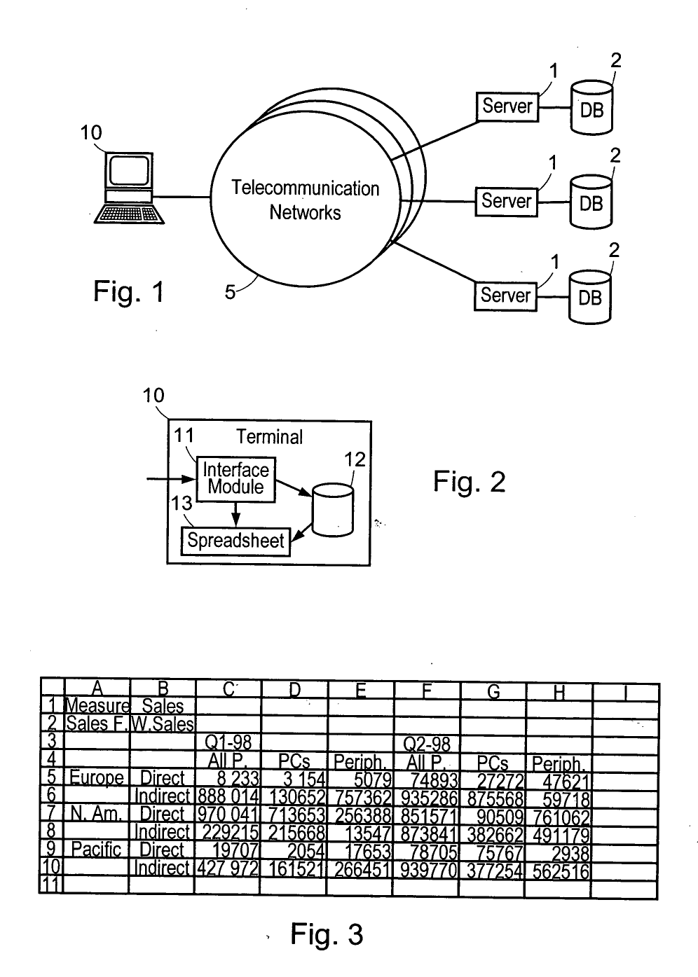

The system shown in FIG. 1 includes a group of servers 1 giving access to respective multidimensional databases 2. The servers are accessible to user terminals 10 via telecommunications or data transmission networks 5.

As shown in FIG. 2, each terminal 10 designed to access to multidimensional databases 2, is equipped with a spreadsheet software 13 such as Microsoft EXCEL designed particularly to handle data displayed in tables consisting of cells distributed in rows and columns.

To be able to access multidimensional databases 2 in accordance with the process according to the invention, the terminal additionally includes an interface module 11 designed to offer the user means for connecting to and accessing servers 1 of databases 2 via a network 5, means for selecting data sets or elementary data blocks in the accessed databases, and means for transferring the elementary data blocks selected into a local database 12.

According to the invention, each elementary data block extracted from a multidimensional database and stored in the local database 12 brings together data and meta-data describing the structure of the data and particularly:
an elementary data block identifier,
an identifier of the multidimensional database 2 from which the elementary data block is extracted,
information for connecting via a network 5, to the server 1 giving access to the database 2, this information including an identifier of the server 1 in the network 5, such as a URL address and access authorization information, such as a user identifier or a password,
a collection of “dimension” objects each defining one of the dimensions of the cube,
“horizontal axis”, “vertical axis”, and “page axis” objects between which the elementary data block dimensions are distributed,
a collection of objects storing the data extracted from the database 2, and
an identifier of a start cell in the spreadsheet in the spreadsheet software, starting from which the extracted data table is inserted, each cell in this table containing a formula that points to a respective data item in the elementary data block stored in the local database, and displays its value in the cell.

Each of the dimensions of an elementary data block brings together the following information:
a dimension identifier,
a collection of hierarchies,
a default hierarchy identifier,
a selected hierarchy identifier,
a collection of hierarchical levels for all the hierarchies defined for the dimension,
a set of dimension properties,
a list of properties selected by the user,
a list of selection criteria to be applied successively to the dimension members,
the results obtained for the dimension by applying the selection criteria, these results containing the labels of the members of the dimension to be displayed.

Thus, for example for a “Customer” dimension, there may be two hierarchies: a hierarchy that groups customers together as a function of their respective geographical location, and another by activity type. The two hierarchies may have common or different hierarchical levels. The “Elementary customer” level is a level common to both hierarchies. In the “Geography” hierarchy a grouping of elementary customers may be found by region (or “region” level), by country (or “country” level), by zone (or “zone” level). In the “Activity” hierarchy it is possible for example to find “activity type” and “activity type category” levels, the three members of this last level potentially being “Services”, “Industry” and “Other”).

Each hierarchy object includes a hierarchy identifier, and a default hierarchy member or value identifier.

Each level object includes a level identifier and a whole number defining the depth of the level.

Each selection criterion object of a dimension object includes a selection type associated with a list of objects and a combination verb defining a combination mode to be applied in respect of other previously defined selection criteria in the dimension selection criteria list.

The possible types for a selection criterion object are as follows:
list: contains the list of dimension members or values, selected by the user,
level: contains the list of levels selected by the user,
top/bottom: defines an upper or lower threshold beyond or within which the values must be selected,
condition: defines a condition that the values to be accepted must verify:
comparison: defines a comparison condition between two values that the members must meet to be selected,
property: defines a condition on member property values to be selected,
character string: defines a condition bearing on a character string that the values must meet to be selected,
sort: defines a sort command to be applied to the selected members,
hierarchy: defines ascendants or descendants of the selected members in their hierarchy to be retained,
server defined lists: allow reference to be made to lists defined in the database,
static list: allows reference to be made to a list defined by the user,
dynamic list: allows reference to be made to another set of selection criteria reevaluated at each execution of the selection criteria,
user: calls on a selection that must be introduced by the user at the time the selection criteria are executed.

The combination verb may take the following values:
add: to add the members of a dimension corresponding to the associated criterion to the members already selected via the previous criteria in the selection criteria list,
keep: to retain only among the members previously selected those corresponding to the associated selection criteria,
remove: to remove from the members that have been previously selected those corresponding to the associated criterion,
sort: to sort the previously selected members by applying the associated sort criterion.

Each value extracted from the remote database and inserted in the local database 12 is associated with a format object defining the value format.

The interface module 11 is designed so as to allow the user to select a server 1 and a database 2, and to connect to the selected database. Once connected, the interface module 11 is designed so as to obtain from the server all the database structure information, namely particularly information related to the database dimensions. This structure information is then displayed on the terminal screen to let the user select in the database a multidimensional cube on which will be based an elementary data block. The structure information is stored in the local database 12 for the selected elementary data block.

The selection information introduced by the user is also stored in the local database 12 in “selection criterion” objects for each dimension of the selected elementary data block.

The interface module 11 is for example activated using a command button or a menu item provided in the spreadsheet software 13. The current active cell of the spreadsheet is considered as the starting default cell (located in the top left hand corner) of the data table extracted from the database and inserted into the spreadsheet.

The interface module connects the terminal to the server 1 accessing the remote database 2 using the connection information stored for the elementary data block in the local database 12. Once the connection of the terminal to the selected database 2 is established, the interface module displays on the screen of the terminal 10 a window including three zones for each of the three page, row and column axes. Each axis is intended to receive dimension identifiers from the database, the user wishes to place on page, row and column respectively.

In the example in FIG. 3, the multidimensional database accessed by the user includes the following dimensions:
“Measure”, “Sales F.” placed on the page axis,
“Geography” and “Customer Type” placed on the row axis, and
“Time” and “Products” placed on the column axis.

The user is then invited by the interface module to introduce selection criteria for each dimension of the data to be extracted from the database.

In the example in FIG. 3, the user has selected:
for the “Time” dimension the “Q1-98” and “Q2-98” members,
for the “Products” dimension the “All P.”, “PCs” and “Periph” members,
for the “Geography” dimension the “Europe”, “N. Am” and “Pacific” members, and
for the “Customer Type” dimension the “Direct” and “Indirect” members.

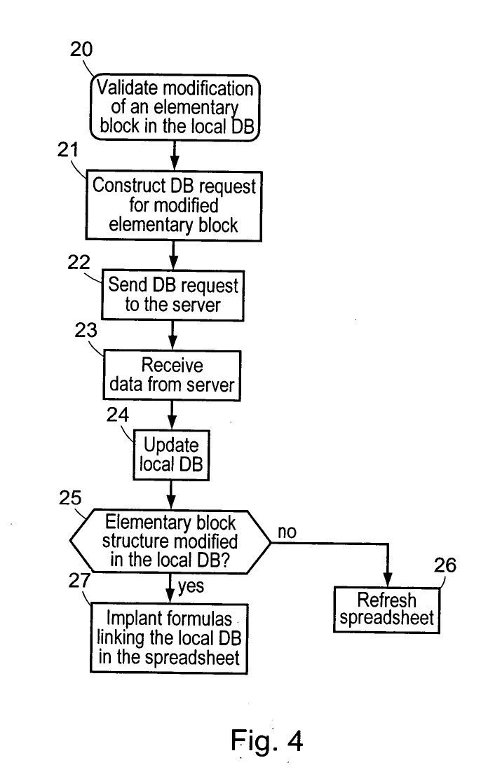

Validation of the selection information introduced by the user triggers the procedure 20 illustrated in FIG. 4.

This procedure includes first of all a step 21 of building a query to access the database 2 based on the information introduced by the user and stored in an elementary data block object in the local database 12. This query has the following form:
SELECT
<syntax defining the selection logic for column dimension members>ON COLUMNS,
<syntax defining the selection logic for row dimension members>ON ROWS,
FROM<CUBE NAME>
WHERE<page dimension filtering members>

The first part of the query (syntax defining the selection logic for on column dimension members) is generated based on the collection of dimensions placed to the column axis. For each dimension object in this collection, the interface module retrieves the selection criteria objects assigned to this dimension object and generates a selection command in the command syntax of the database 2 for each of the selection criterion objects found in the local database 12 for this dimension object on the column axis.

The same procedure is then applied to the row axis dimension objects to define the selection logic syntax for row dimension members.

The last part of the command (related to page dimension members acting as filters) reverts to the selection criteria to be applied to the dimension objects allocated to the page axis.

Once the query command is constructed, the interface module 11 starts the execution of the query by transmitting it to the server 1 associated with the database 2 to which it is connected (step 22).

At the next step 23, the module 11 receives from the server 1 the response corresponding to the query issued and containing the data extracted from the database 2.

At the next step 24, the data received is stored in the local database 12 in association with other information relating to the processed elementary data block.

At the next step 25, if the structure of the data stored in the local database for the elementary data block being processed is not modified, the interface module transmits to the spreadsheet software a refresh command (step 26) that consists simply in getting the spreadsheet software to execute the different formulas inserted in the spreadsheet. Conversely if it is a first data extraction or a new extraction in which the extracted data has a modified structure relative to the data extracted during a previous query execution, the interface module, 11 inserts into each of the cells in the table presented in the spreadsheet a link formula so that the spreadsheet software can display the corresponding extracted value stored in the local database 12 (step 27). These link formulas relate to both the values to be displayed in the table cells, and to the elementary data block dimension and dimension member labels, displayed in the spreadsheet, in accordance with the example shown in FIG. 3.

The user can thus define several elementary data blocks to be extracted from one or more databases 2, and present them in the form of tables in a spreadsheet, and using the spreadsheet software, associate with them a presentation and calculation formulas related to the extracted data.

Advantageously a function is provided that allows a number of elementary data blocks extracted from the same database 2 or from different databases to be linked together, in such a way that they present one or more dimensions in common and that the selection criteria applied to one or several dimensions in common for an elementary so-called “master” data block are also used to select the data to be extracted for another elementary so-called “slave” data block.

To this end, the interface module is designed so as to offer the user the facility to link dimension objects of the elementary slave data block to dimension objects of an elementary master data block. To do this, the interface module allows an elementary master data block and an elementary slave data block to be selected. Once this selection has been made by the user, the interface module displays the identifiers of the dimension objects of each of the data sets in two separate windows and offers the user the facility to link dimensions of the elementary master data block with dimensions of the elementary slave data block.

This information is stored in the form of an additional selection criterion type defined for each linked dimension of the elementary slave data block, and which is associated with a reference to the defined selection criteria for the linked dimension of the elementary master data block.

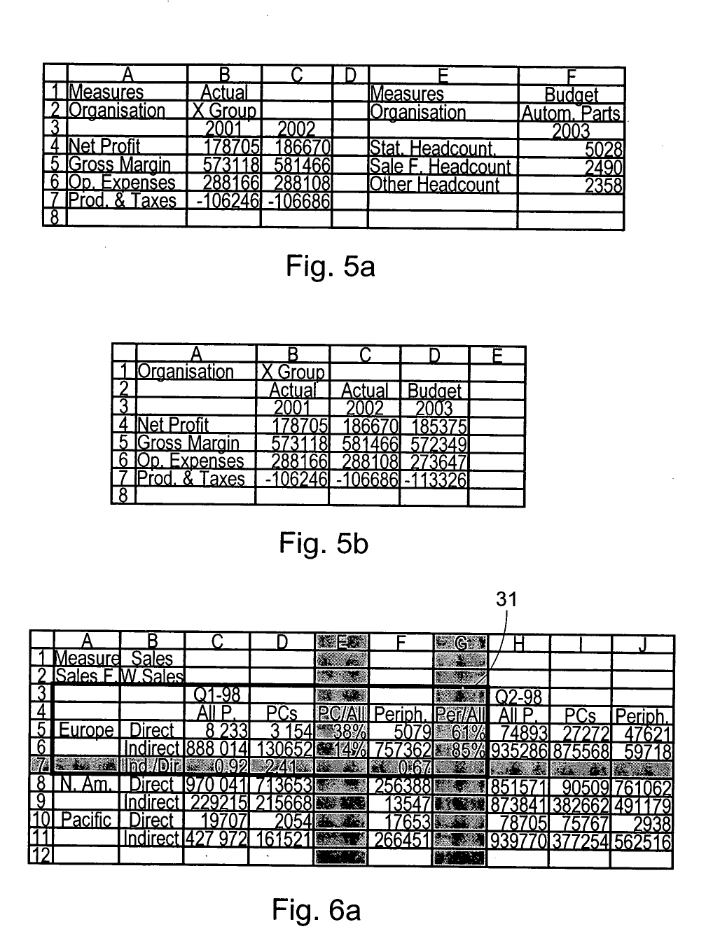

In the example shown in FIG. 5a, the user has inserted into a spreadsheet two elementary blocks, the first block being inserted in columns A to C and the second block in columns E and F. The data displayed in these two elementary blocks is inconsistent. To obtain consistency, the user can for example link together the “Rubric” dimensions located on the row axis of the two blocks, and the “Organization” dimensions located on the page axis of the two blocks, the second block being the slave block of the first master block.

Once the user has so selected the dimensions to be linked, the interface module associates in the local database 12 each dimension object of the elementary slave data block linked to a dimension object of the elementary master data block, using a reference link pointing to the dimension object of the elementary master data block to which it is linked. This reference link may for example be achieved by providing a particular selection criterion type of the link type to another elementary data block, indicating to the interface module 11 that it must revert to the selection criteria defined for a dimension object of another elementary data block. This criterion type must therefore be associated with an elementary master data block identifier and a dimension identifier of this elementary master data block.

During the execution of step 21 of constructing the query for the extraction of the elementary data block, if the interface module comes across in the structure of the elementary data block for which it is constructing the extraction query command a selection criterion object of the link type to another elementary data block, it retrieves, in the local database 12, the elementary data block and the dimension object of this elementary data block designated by the selection criterion of the link type to another elementary data block, and integrates into the query the selection criteria defined by the selection criteria objects associated with the elementary master data block dimension so designated. The selection criteria for a linked dimension of an elementary slave data block that are taken into account in constructing the query to the database 2 are those of the linked dimension of the elementary master data block.

To ensure consistency of the two data sets, it is moreover necessary to revert to the selection of dimensions assigned to the page axis of the elementary master data block.

It is possible additionally to change the slave block display properties so as not to display the labels of the linked dimension members, these being displayed for the master block, or conversely to display the labels in the middle of the table grouping master block and slave block together.

The execution of the second (slave) block query in the example in FIG. 5a makes it possible to obtain the table shown in FIG. 5b. The data coming from the slave block is arranged in column D. The user can then change the selection criteria of the “Rubric” on row dimension or the “Organization” on page dimension and obtain consistent results between the two elementary blocks.

Clearly, the procedure that has just been described is transitive since the elementary master data block can itself be the slave of another elementary master data block. To prevent this procedure going into an endless loop, the interface module 11 is designed to detect any “circular reference” and to inform the user of such.

This procedure is also executed for all the elementary slave data blocks of an elementary master data block for which the selection criteria have been modified.

In the case of a re-execution of a query with a new extraction of an elementary data block, the case when the elementary data block structure is not modified, but where the number of dimension members extracted to be displayed is modified (number of rows and/or columns of the table inserted into the spreadsheet is modified) is detected. In this case, the table inserted into the spreadsheet is updated in such a way as not to affect the spreadsheet cells located outside the table before it is updated. The user can therefore insert into the spreadsheet outside the inserted table calculation formulas that relate to the values displayed in the table and cause the query to be re-executed by changing selection criteria, while retaining the formulas he has introduced, and the table cell presentation that he has defined using the spreadsheet software features.

On the other hand, if he inserts intermediary rows or columns calculations into the table, these are deleted when the query is re-executed if the extracted data block structure is modified or if the number of members in a dimension is changed.

Additionally, if the user wishes to apply the same formula or the same set of formulas to all the members of a displayed dimension, he must insert the set of row or column formulas manually as many times as there are members displayed for given the dimension. This operation is tedious and the result will be lost upon next extraction query execution with a new data structure or with a different number of members for a dimension.

To preserve the inserted rows and columns, some tools or languages for querying data from a multidimensional database 2 provide the facility to insert calculation formulas into an extraction query. In this case, the defined calculations are computed by the database server during the execution of the query. These multidimensional calculation formulas are executed for all the members of the involved dimensions. They must comply with a powerful yet complex syntax that is all the more beyond the reach of an end user.

Therefore, most query languages prove inaccessible to non-multidimensional databases specialists.

To solve this problem, the present invention provides an additional function extending the multidimensional calculation to local spreadsheet formulas inserted by the user. To meet this objective, the interface module is designed to duplicate automatically a set of cells known as an “instance” by modifying the references in the inserted formulas to point to the data located in the local database. An instance groups together spreadsheet cells that have in common a member of each row and/or column dimension for which the extension function has been activated, as well as the calculation formulas inserted by the user and related to these values.

The reference instance that is duplicated by the extension function is the first instance, in other words the first member of each of the dimensions where the extension function is active and all the values corresponding to these members for all the other dimensions, as well as the calculation formulas inserted by the user and related to these values.

Duplication is thus carried out for all the other instances of the dimensions where the extension function is active.

To insert calculation formulas into an elementary block table inserted into a spreadsheet, all that is required therefore is to insert into the cell set of the first instance new rows and/or columns, as well as the desired local calculation formulas, and the interface module duplicates this first instance so as to propagate the modifications made by the user to the other dimension members where the extension function is active. The local multidimensional calculation objective is thus reached.

The interface module 11 is designed to allow the user to select dimension objects of an elementary data block stored in the local database 12 and to specify that he wishes to activate this extension function to the selected dimensions. An extension function activation indicator is stored in the local database 12 in association with each dimension object.

Obviously, this function is not active at the first execution of a data set extraction query and considers that the user has already executed the elementary data block query and modified the table inserted in the spreadsheet for this elementary block by inserting additional rows and/or columns containing local calculation formulas, in the first instance of the selected dimensions.

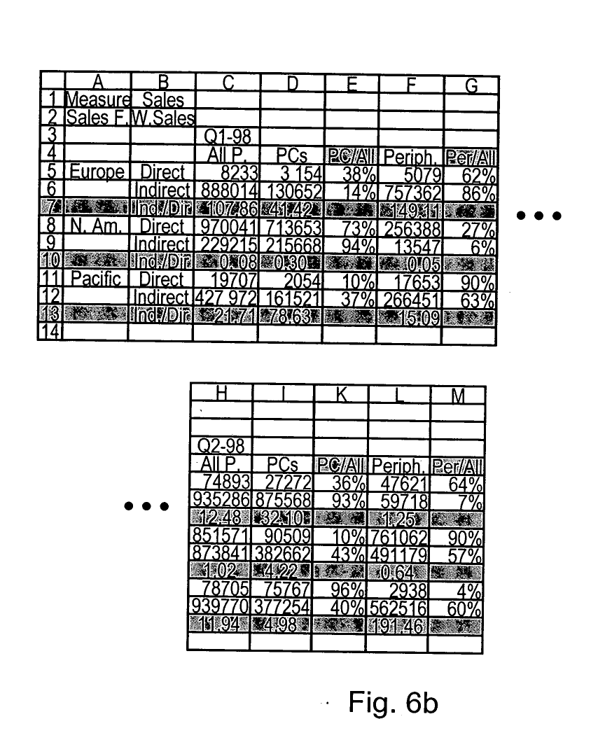

Going back to the example in FIG. 3, the user has executed in a first run the elementary block query to obtain the table shown by this figure. Then he modifies this table so as to obtain the table shown in FIG. 6a. In this table the user has inserted row 7 in which he has added in column B the label “Ind/Dir” and in column C the formula C5/C6. He has then recopied this formula into columns D and E (in FIG. 3) so as to apply this formula also to the values in these columns. The next lines have been automatically re-numbered by the spreadsheet software. By recopying this formula, the spreadsheet software has converted it automatically into D5/D6 and E5/E6.

The user has then inserted columns E and G (FIG. 6a) in which he has inserted the labels PC/All and Per/All in row 4, and in rows 5 and 6 formulas of the type 100*D5/C5 and 100*D6/C6 for column E and 100*F5/C5 and 100*F6/C6 for column G.

The user then activates the function of extension to the “Time” and “Geography” dimensions.

When re-executing the query associated with the elementary data block, the calculation module analyses the spreadsheet by taking into account the dimensions for which the user has activated the extension function. It determines the range of cells corresponding to the first instance of these dimensions, reads the values and formulas contained in this range of cells and copies this range of cells in the spreadsheet as many times as there are new members in each of the dimensions for which the extension function is activated. Before each copy, it modifies the elementary block value formulas so as to point to the corresponding member in the local database.

Furthermore, during this insertion, the spreadsheet software automatically modifies by itself the calculation formulas inserted by the user so as to make them relate to the cells of the new instance.

Thus in FIG. 6a, the first instance to be recopied is delimited by the rectangle 31 in thick lines. The interface module duplicates this instance for all the dimension members where the extension function has been activated, by calling on the spreadsheet software recopy function and by modifying the local database value insertion formulas, which makes it possible to obtain the table shown in FIG. 6b.

In this example, the interface module begins copying the instance for all the dimension members on the column axis, in other words in the example of FIG. 6c, for all the periods, then it duplicates the first instance associated with the instances that have just been copied for all the dimension members on the row axis, in other words in the example in FIG. 6c, for all the members of the “Geography” and “Rubric” dimensions.

Of course, if selection criteria associated with dimensions are changed, the number of members of these dimensions is modified, the interface module adapts as a consequence the number of copies of the first instance to be made in the spreadsheet. For example if the number of periods to be displayed is modified, columns C to G are duplicated as many times as there are periods for all the values and the labels of the period dimension members returned by the new query in the local database.

As a result of the preceding, the process according to the invention leverages the benefits of spreadsheet software that is widely used in business applications by knowledge end users who are not obviously database specialists. A first benefic of this type of software the invention takes advantage of is the ease of defining calculation functions on the data displayed in the cells, these calculations potentially being complex while being within the reach of a spreadsheet end user. Another benefit the invention takes advantage of lies in the copy/paste function that automatically updates the references to cells in the calculation duplicated formulas depending on the position of the cell where the formula is copied.

1. A method for handling data stored in at least one multidimensional database in which data is structured according to a number of dimensions, comprising steps of:
generating a query for data to be extracted from a multidimensional database based on selection criteria introduced by a user relating to at least part of the dimensions of the multidimensional database,
executing the data extraction query on the multidimensional database so as to receive data extracted from the multidimensional database and corresponding to the selection criteria introduced by the user,
storing the data received in the form of an elementary data block in a local database, and
inserting into cells of a spreadsheet formulas for displaying a data item that point to a respective data item of the elementary data block stored in the local database.

2. The method according to claim 1,
wherein the selection criteria introduced by the user for an extracted elementary data block are stored in the local database in association with the extracted and stored elementary data block data.

3. The method according to claim 1,
further comprising steps of generating and executing a number of data extraction queries, as a function of selection criteria introduced by the user so as to receive a number of elementary data blocks, each of the extracted elementary data blocks being stored in the local database, and inserted in the form of a respective table into the spreadsheet as a function of the selection criteria introduced by the user for each of the extracted elementary data blocks.

4. The method according to claim 3,
further comprising a step of linking at least one dimension of an elementary slave data block to an elementary master data block, the generation of the query for extraction of the elementary slave data block integrating the selection criteria applied to the linked dimension of the elementary master data block.

5. The method according to claim 4,
wherein the linked dimension of the elementary master data block is itself linked to a dimension of another elementary data block, the selection criteria applied to the dimension of the other elementary data block are applied to the linked dimension of the elementary slave data block.

6. The method according to claim 4,
wherein each time a criterion for selecting a linked dimension of a master elementary master data block is modified, the queries extracting the elementary slave data blocks from the elementary master data block are generated and executed again so as to update the cells in the tables of the elementary data blocks inserted into the spreadsheet.

7. The method according to claim 1,
further comprising a procedure for extending multidimensional calculation to at least one dimension of an elementary data block, including a step of identifying in the spreadsheet a set of cells bringing together cells containing data item display formulas that point to respective data in an elementary data block, corresponding to a first respective member of each of the dimensions of the elementary block for which the extension procedure has been activated, and cells inserted by the user, and steps of duplicating the identified cell set, carried out for each of the members of each of the dimensions for which the extension procedure has been activated, each duplication being carried out by modifying the data display formulas of the elementary data block, belonging to the identified cell set, so as to insert an elementary data block corresponding to the members for which the duplication is being carried out.

8. The method according to claim 7,
wherein the cells inserted by the user in the identified cell set contain at least partially calculation formulas that reference cells in the identified cell set, the identified cell set being duplicated by updating the references of the cells that feature in the calculation formulas inserted by the user as a function of the location in the spreadsheet where the identified set is inserted.

9. A system for handling data stored in at least one multidimensional database in which data is structured according to a number of dimensions, said system comprising an interface module coupled with a spreadsheet software and having access to at least one multidimensional database to extract elementary data blocks from the multidimensional database and insert them into a spreadsheet, and a local database in which the interface module stores the extracted elementary data block data, the interface module including:
means for generating queries for extracting elementary data blocks from the multidimensional database based on selection criteria introduced by a user relating to at least part of the dimensions of the multidimensional database,
means for getting the multidimensional database to execute the generated extraction queries,
means for receiving the extracted elementary data blocks and storing them in the local database, and
means for inserting into cells in the spreadsheet data item display formulas that point to respective data items in the elementary data block stored in the local database.

10. The system according to claim 9,
wherein the multidimensional databases are accessible to the interface module via a data network.

11. The system according to claim 9,
wherein the local database stores several elementary data blocks extracted from multidimensional databases, the interface module including means for allowing the user to link together at least one dimension of an elementary slave data block and a corresponding dimension of an elementary master data block, and means for integrating the selection criteria applied to the linked dimension of the elementary master data block into the elementary slave data block extraction query.

12. The system according to claim 9,
wherein the interface module further comprises means for retrieving all the elementary blocks stored in the local database that include at least one dimension linked to an elementary master block when a criterion for selecting the corresponding linked dimension of the elementary master block is modified, means for generating and executing queries for extracting the elementary slave blocks found and means for updating the cells in the data tables of the elementary blocks inserted into the spreadsheet, following the execution of the extraction queries.

13. The system according to claim 9,
further comprising means for identifying in the spreadsheet a cell set that groups together cells containing data item display formulas that point to a respective data item in an elementary data block, corresponding to a first respective member of at least one dimension of the elementary block for which a multidimensional calculation extension procedure has been activated, and cells inserted by the user, means for duplicating the identified cell set for each of the members of each of the dimensions for which the extension procedure has been activated, each duplication being carried out by modifying the elementary data block data display formulas, belonging to the identified cell set, so as to point to elementary block data corresponding to the members for which the duplication is being carried out.

14. The system according to claim 9,
wherein the cells inserted by the user in the identified cell set contains calculation formulas that reference cells in the identified cell set, the identified cell set being duplicated by updating the references of the cells that feature in the calculation formulas inserted by the user as a function of the location in the spreadsheet where the identified set is copied.
